(19) United States
(12) Patent Application Publication
(10) Pub. No.: US 2006/0268553 A1
(43) Pub. Date: Nov. 30, 2006

(54) Method and apparatus for gem stone enhancement

(76) Inventors: Willis Albert Potter, Dallas, TX (US); Alfred E. Hall, Dallas, TX (US)

Correspondence Address: Alfred E. Hall, 14943 Hillcrest Rd., Dallas, TX, 75248, US

(21) Appl. No.: 11/138,116

(22) Filed: May 26, 2005

(51) Int. Cl. F21V 14/04

(52) U.S. Cl. 362/322; 362/282; 362/342

(57) ABSTRACT

A method and apparatus for enhancing the esthetic appearance of gem stones by creating points of constructive light interference and moving the points of constructive light interference across gem stones to create flashing reflected light from the gem stones thus enhancing their esthetic appearance.

### BACKGROUND OF THE INVENTION

1. Field of the Invention

The present invention relates in general to the enhancing the esthetic appearance of jewelry, especially gem stones having a plurality of light reflecting surfaces or faces, and in particular to a method and apparatus for the use of a grating structure spaced from and above the surface on which the gem stones are located, placing a light source above and spaced from the grating, and oscillating the light source with respect to, across, and in a direction perpendicular to the gratings such that reinforced light waves generated by the light passing through the grating move across the gem stones and cause light to be reflected from the light reflecting faces of the gem stones (hereinafter referred to as “gems”).

2. Description of the Prior Art

Applicants are aware of the light reflecting properties of the light reflecting surfaces of gems. When a jeweler is presenting a gem to a customer, the jeweler generally rocks the gem back and forth under a light source so that the light is reflected off of the moving gem surfaces, or faces, to enhance the esthetic appearance of the gems.

It would be advantages if a plurality of gems on a surface were all reflecting light from their many faces simultaneously so that an individual passing by would be attracted to the esthetic appearance of the gems positioned on the surface.

### SUMMARY OF THE INVENTION

Applicants are aware of the interference patterns produced when light is passed through closely spaced slits in a screen. As shown in FIG. 1, with a diffraction grating having spaced grates, the incident light is scattered by each of the spaced gratings. Such gratings could be spaced, elongated dowels, elongated grooves cut in a glass plate, or molded into a plastic sheet, and the like. It is well known that all scattered wavelets are in phase along a line inclined at an angle of sin θ=λ/d where λ=wavelength and d=the groove spacing as shown in FIG. 1. This inclination constitutes a wave front of a new plane wave, traveling at an angle θ with respect to the incident beam of light, and of the same wavelength and frequency.

It is also well known that incident light passing through a grating is diffracted by each of the grates (or grooves). For a given wavelength, λ, the light is visible only in that direction in which light from each grating (groove) interferes constructively with that of the others.

Applicants do not understand all of the principles involved in diffraction gratings. However, they have discovered that when a light source is placed above and spaced from a grating structure and the grating structure is placed above and spaced from a surface on which gems are placed, a movement of the light source with respect to the gratings in a direction perpendicular to the gratings longitudinal axis causes the gems to sparkle and reflect light from their many reflecting surfaces. It is believed that the respective movement of light across the grating structure in a direction perpendicular to the gratings causes a change in the angle of refraction of the light waves thus causing the gem surfaces to reflect the passing light.

In applicant's experiments, they have found, for example only, that a light source placed 1 unit above the grating structure and with the grating structure placed 2 units above the surface on which the gems are positioned, a substantial amount of reflections from the gems occur. Thus, if the light source is placed one (1) foot above the grating structure, the grating structure could be placed two (2) feet above the surface on which the gems are placed. However, applicants have also found that some reflections from the gems occur with all ratios of light source spacing above and from the grating structure to the spacing of the grating structure above the surface on which the gems are positioned.

For a light source, applicant's used a halogen spot light and for the grating structure, applicant's used a plurality of wood dowels of approximately 18 inches in length and ⅜ inch in diameter that were spaced ⅜ inch apart and attached to wood supports at each end. Obviously different length grating structures could be used as well as different diameter dowels. Under the proper conditions, grooves in glass or plastic could also be used as the grating structure or light diffraction device. The light source was moved by hand in a direction perpendicular to the longitudinal axis of the dowels. Also, the wood grating structure was moved with respect to the light. Both systems worked equally well. The system was tested with the light source spaced at different distances from the wood dowels and the wood dowels spaced at different distances from the gem. It appeared to applicants that the greatest light reflections from the gem occurred with a ratio of ½. In other words, the light was placed at a distance of one (1) foot from the wood dowels and the wood dowels were placed at distance of two (2) feet from the gem.

Applicants believe that the use of a point source light would greatly enhance the light reflections from the gems. For example, it is well known that a light striking the 45° face of a 45° light reflecting prism that the light will be reflected at the angle of 45°. With the use of such a prism and using a power source to arcuately oscillate, or rock, the prism about its longitudinal axis, the reflected light would scan across the grating structure back and forth in the arcuate manner. To one skilled in the art, there would, of course, be many different methods of oscillating a light source with respect to the grating structure in a direction perpendicular to the longitudinal axis of the gratings. For instance, the grating structure could be oscillated with respect to the light source and the gems.

Further, to one skilled in the art, may different types of light sources could be used to create the light reflections from the gems.

Thus it is an object of the present invention to enhance the esthetic appearance of gems that are placed on a surface for viewing.

It is also an object of the present invention to scan diffractions from a light source across the gems to enhance their esthetic appearance.

It is a further object of the present invention to scan a light source with respect to a grating structure placed above and spaced from the gems to cause enhanced light reflections from the gems.

Thus, the present invention relates to apparatus for enhancing the esthetic appearance of gems having at least one face from which light is reflected comprising a grating structure above and spaced from a surface on which the gems are located; a light source above and spaced from the gratings; and scanning means for causing the light source to move with respect to the grating structure in a direction perpendicular to the longitudinal axis of the gratings in an oscillating manner so that scattered light waves from the grating structure move across the surface on which the gems are located causing reflection of light from the gem faces and creating a sparkling effect from the gems.

The invention also relates to a method for enhancing the esthetic appearance of gems having at least one face from which light is reflected comprising the steps of placing a light source above and spaced from a surface on which gems are placed; and causing light waves from the light source to interfere with each other both constructively and destructively to generate secondary wavelets that reflect from the gem faces to create a sparkling effect.

### BRIEF DESCRIPTION OF THE DRAWINGS

These and other more detailed objects of the invention will be more completely described in the following DETAILED DESCRIPTION OF THE DRAWINGS in which like numerals represent like objects and in which:

FIG. 1 is a diagrammatic representation of a well known diffraction grating;

FIG. 2 is a diagrammatic representation of the apparatus of the present invention illustrating a light source spaced from and above a grating structure that is also spaced from and above a surface on which the gems are placed to allow the light source to be moved with respect to the grating structure in a direction perpendicular to the longitudinal axis of the grating structure to cause light reflections from gem surfaces and enhance their esthetic appearance;

FIG. 3 is a schematic representation of a 45° prism that reflects light from the angled surface at an angle of 90° and that could be used to oscillate light from a light source perpendicular to and across the longitudinal axis of a grating structure; and

FIG. 4 diagrammatically represents a system for oscillating a 45° angled elongated mirror to cause light to be scanned perpendicular to and across the longitudinal axis of a grating structure.

### DETAILED DESCRIPTION OF THE DRAWINGS

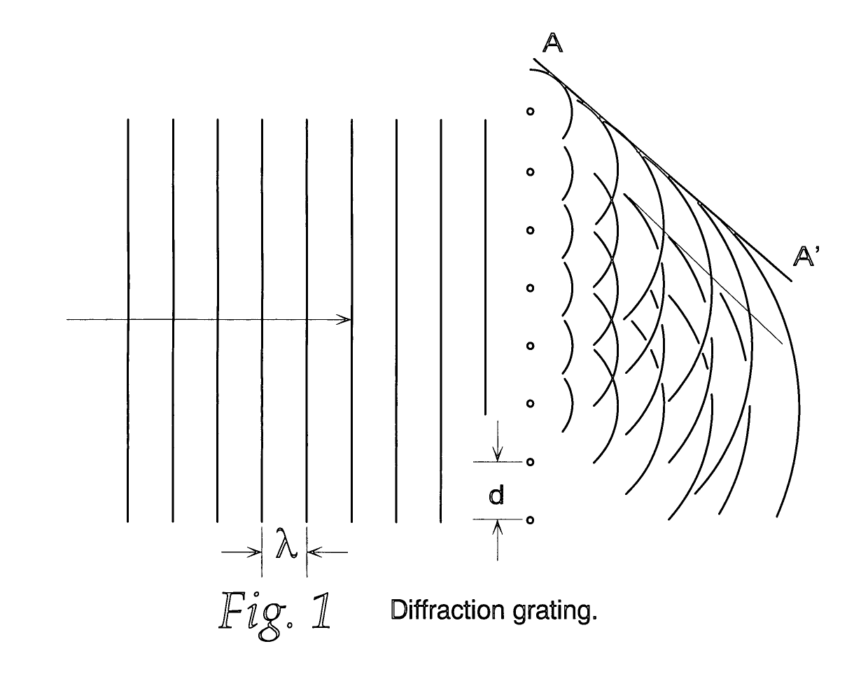

FIG. 1 illustrates a well known diagram for explaining the operation of a diffraction grating. If light source creates an incident wave having a wavelength, λ, that is directed to a diffraction grating structure having grooves or gratings that are spaced apart by a length, d, scattered wavelets propagate radially outward from each groove or grating. Along the line AA′ inclined at sin θ=λd, all scattered wavelets are in phase. It can be seen that the scattered wavelets form points of constructive interference and points of destructive interference.

It is believed by applicants that if a light source is moved with respect to the diffraction grating in a direction perpendicular to the longitudinal axis of the grating structure, the points of constructive interference also move across the gems causing light to be reflected from the gem faces causing them to sparkle as if rocked back and forth under a light source.

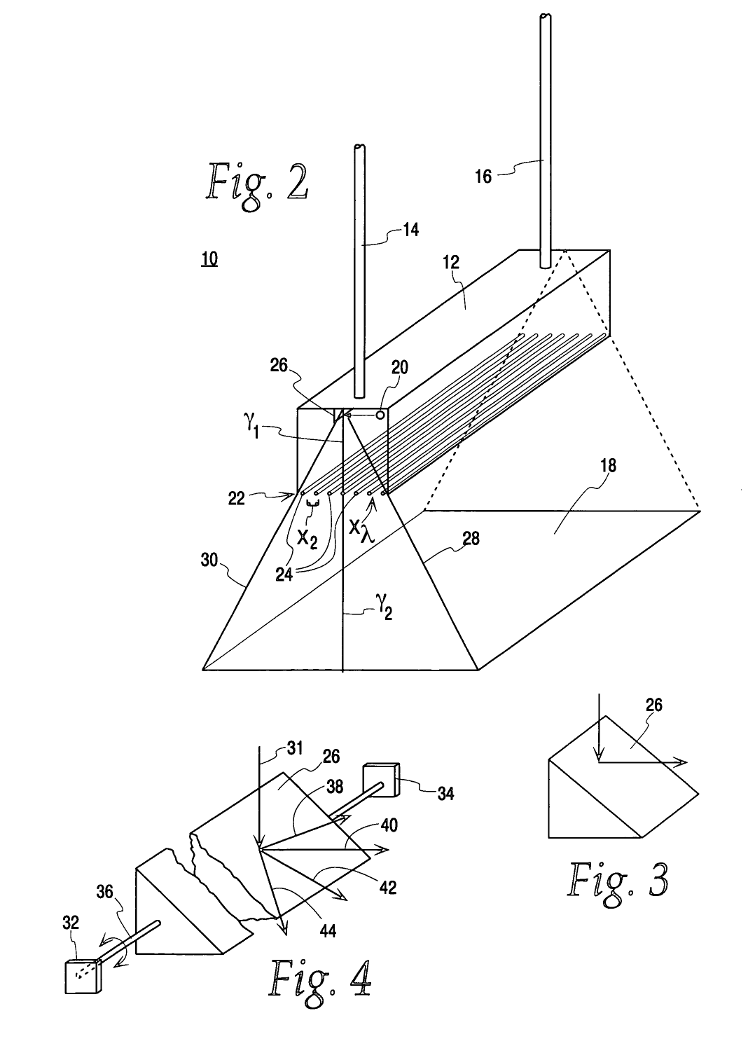

FIG. 2 is a schematic representation of apparatus of the present invention that produces the esthetic enhancement of gems as explained above. The apparatus 10 includes a partial enclosure 12 that is open at the bottom. The enclosure 12 is supported at 14 and 16. One of the supports 14 and 16 may be hollow to carry electrical power to a light source 20 contained therein. The enclosure 12 is spaced above a surface area 18 on which gems are placed for viewing. At the bottom of the enclosure 12 is located a grating structure 22 formed of a plurality of spaced apart elongated gratings 24. The light source 20, which may be a point source of light, is directed toward the downwardly facing angle of a mirror 26. If the angled mirror is rocked in an arcuate manner, the light is scanned across the gratings 24 at an angle from line 28 to line 30.

As explained above, it is believed that the light, moving across the gratings in a direction perpendicular to the longitudinal axis of the gratings, causes constructive and destructive interference of the scattered wavelets thus moving patterns of light that strike the gems at different angles and cause reflection of light from the various surfaces of the gems to create a sparkling effect. Thus, the esthetic appearance of the gems located within the surface area 18 is enhanced.

FIG. 3 is a diagrammatic representation of a mirrored prism 26 having a 45° face that will reflect light at an angle of 90° as shown when light strikes the angled face. Such mirror is well known in the art and has been used extensively for changing the angle of a transmitted light.

FIG. 4 is a diagrammatic representation of one way to cause the angled mirror 26 to scan across a surface. The mirror 26 is mounted on shaft 36 supported by blocks 32 and 34. In one of the blocks 32 and 34, a cam, driven in any well known manner, causes the mirror 26 to rock arcuately between two points. Since such driving mechanisms are old and well known in the art, no description will be provided here. Thus, in FIG. 2, the mirror 26 can rock arcuately to cause the reflected light to move between the two sides 28 and 30 of a triangle. As can be seen in FIG. 4, the incident light 31 is reflected at such angles as indicated by arrows 38, 40, 42, and 44.

Of course, the light must be moved with respect to the longitudinal axis of the grating structure in a direction perpendicular thereto. Thus, instead of the light moving, the grating structure could be moved in an oscillatory fashion with respect to the light source.

As stated earlier, reflections from the gem surfaces will occur with any spacing between the light source and the grating structure and between the grating structure and the surface on which the gems are placed.

However, applicants have found, by experimenting, that it appears that a substantial amount of reflections occur from the gems when a ratio of 1 to 2 occurs between the distance of the light source from the grating structure and distance of the grating structure from the surface area on which the gems are located when used with grating sizes and spaces as set forth earlier.

With this ratio, if the light source is spaced 1 unit of distance above the grating structure, then the grating structure should be placed two units of distance above the surface on which the gems are placed. Thus, in FIG. 2, if the distance, y¹, of the light source (mirror 26) above the grating structure is one (1) foot, the distance, y², of the grating structure 22 above the surface area 18 is two (2) feet.

Further experiments may find other such distance ratios to be of value especially when the dowel and spacing size changes. It is also believed that different types of light sources may be used. For instance, in FIG. 2, the light source 20 may be an elongated light source located within an enclosure with a slit or elongated opening in the structure that is parallel to the mirrored prism 26 so that light from the source will be directed primarily to the angled surface of the prism 26.

As explained earlier, applicants do not understand the precise manner in which the novel invention causes the esthetic appearance of the gems to be enhanced and the flashing lights reflected from the gem faces to be created. However, the effect is known to be created and the above explanation attempts to explain why the applicants believe that the device operates as it does.

With such explanation, the invention also includes a method of enhancing the esthetic appearance of gems. The method includes the steps of placing a light source above a surface on which gems are located and causing moving points of constructive interference of light to pass over the gems thus creating reflections of light from the surfaces of the gems to enhance the esthetic appearance of the gems.

Thus, there has been disclosed a novel apparatus and method of enhancing the esthetic appearance of gems.

While the invention has been described in connection with a preferred embodiment, it is not intended to limit the scope of the invention to the particular form set forth, but, on the contrary, it is intended to cover such alternatives, modifications, and equivalents as may be included within the spirit and scope of the invention as defined by the appended claims.

We claim:

1. A device for enhancing the esthetic appearance of gem stones having at least one face from which light is reflected comprising:
a grating structure above and spaced from a surface on which at least one gem stone is located;
a light source above and spaced from the grating structure; and
light moving means for causing the light source to move perpendicular with respect to the longitudinal axis of the gratings in an oscillating manner so that scattered light waves from the grating move across the surface on which the at least one gem stone is located causing reflection off of the at least one gem stone face and creating a sparkling effect from the at least one gem stone.

2. A device for enhancing the esthetic appearance of gem stones having at lease one face from which light is reflected comprising:
a diffraction grating above and spaced from a surface on which at least one gem stone is located;
a light source above and spaced from the gratings; and
light moving means for causing the light source to move perpendicular to the gratings in an oscillating manner so that scattered light waves from the diffraction grating move across the surface on which the at least one gem stone is located causing reflection off of the at least one gem stone face and creating a sparkling effect from the at least one gem stone.

3. The device of claim 2 wherein the light source is a point light source.

4. A method of enhancing the esthetic appearance of gem stones having at least one face from which light is reflected comprising the steps of:
placing a grating structure above and spaced from a surface on which at least one gem stones is located;
placing a light source above and spaced from the grating structure; and
causing the light source to move perpendicular to the gratings in an oscillating manner so that scattered light waves from the grating structure move across the surface on which the at least one gem stone is located to create reflection from the at least one gem stone face and creating a sparkling effect from the at least one gem stone.

5. A method of enhancing the esthetic appearance of gem stones, each gem stone having faces from which light is reflected comprising the steps of:
placing a light source above a surface on which a plurality of gem stones are located; and
causing points of constructive light interference from the light source to pass over the surface on which the gem stones are located to create flashing reflected light from the gem stone faces thus enhancing the esthetic appearance of the gem stones.

6. The method of claim 5 further comprising the steps of:
forming the points of constructive light interference with an elongated diffraction grating; and
moving the elongated diffraction grating in an oscillatory manner with respect to the light source in a direction perpendicular to the longitudinal axis of the diffraction grating to create the points of constructive light interference.

7. The method of claim 6 further comprising the step of moving the light source across the diffraction grating to create the points of constructive light interference.

8. The method of claim 6 further comprising the step of moving the diffraction grating in front of the light source to create the points of constructive light interference.
